(19) United States
(12) Patent Application Publication
(10) Pub. No.: US 2015/0202753 A1
(43) Pub. Date: Jul. 23, 2015

(54) HAND TOOL, IN PARTICULAR A SOLDERING GUN, WITH LIGHTS

(71) Applicant: APEX BRANDS, INC., Apex, NC (US)

(72) Inventor: Gert Mittmann, Mockmuhl (DE)

(21) Appl. No.: 14/420,980

(22) PCT Filed: Aug. 14, 2013
(86) PCT No.: PCT/EP2013/002440

§ 371 Date: Feb. 11, 2015

(30) Foreign Application Priority Data
Aug. 21, 2012 (DE) 20 2012 007 997.2

(51) Int. Cl. B25B 23/18; F21V 33/00; F21V 19/00; B23K 3/03

(52) U.S. Cl. CPC B25B 23/18; B23K 3/0338; F21V 33/0084; F21V 19/0025; F21W 2111/10

(57) ABSTRACT

The invention relates to a hand tool, in particular a soldering gun, having at least one handle and a tool element protruding therefrom with an actuating end section on the free end. The hand tool also has more than one light for illuminating an installation location of the hand tool.

The present invention refers to a hand tool, in particular a soldering gun, having at least one handle and a tool element protruding therefrom. The tool element comprises an actuating end section on its free end. By operating the handle, an operator, or the like, can correspondingly use the actuating section, for instance, in order to tighten a screw, carry out a soldering operation, or the like. The tool element thereby establishes a corresponding connection between handle and actuating end section.

With various applications of the hand tool it might happen that there is not enough light for illuminating a place of use of the hand tool. This may e.g. be due to the fact that the operator is standing between the place of use and ambient light, thereby shadowing the place of use relative to the ambient light. So far it has been possible that in addition to the hand tool the operator uses for instance a light source in one hand or uses it at a corresponding place of his/her body, e.g. on a helmet, or the like.

However, whenever the light source is used separately, only one hand can be used for handling the hand tool. If the light source is e.g. positioned on a helmet, it is not always ensured by correspondingly pivoting or arranging the head that the place of use is really illuminated.

It is therefore the object of the present invention to improve a hand tool such that without detriment to the operator and thus his/her handling of the hand tool an adequate illumination of the place of use is reliably possible in a simple and inexpensive manner.

This object is achieved by the features of the claim.

According to the invention the hand tool comprises more than one light for illuminating the place of use. This means that the corresponding lights are part of the hand tool and are moved along with the same. It is ensured in this connection by the corresponding alignment of the lights that independently of the alignment of the hand tool the corresponding place of use and thus substantially the actuating end section of the hand tool is illuminated without any shadow.

A separate light source is not required. The corresponding illumination is also carried out independently of corresponding movements of the operator e.g. with the head, as the illumination is directly carried out by the hand tool and in alignment with the place of use.

To prevent a situation where the lights possibly impair the operator's view when arranged on the tool element or on the fastening end section, the lights may be arranged on the handle.

In this connection, in order to change the handle by the arrangement of the lights as little as possible, the lights may be arranged on an end flange of the handle that at least partly surrounds the tool element. Owing to this arrangement the lights are arranged as close as possible to the tool element and thus to the actuating end section.

The corresponding end flange normally forms a transition from the handle to the tool element, and it is here possible in this connection that e.g. the tool element together with the operating end section is an exchangeable part. This exchangeability is implemented independently of the lights as the lights are arranged on the handle.

The handle and the handle end flange, respectively, may comprise a corresponding handle end face, and for the alignment of the lights it may here be regarded as an advantage when the lights are arranged in said handle end face oriented from the handle substantially towards the place of use.

The distance between handle and place of use is only a few centimeters in most hand tools, i.e. the corresponding distance is normally in the range of 5 cm to 25 cm. At this distance and for the adequate illumination of the place of use a small radiation angle of the light is normally of advantage. This means that a radiation angle of each light may lie between 5° and 30° and preferably between 8° and 20°.

This leads to a spot-like illumination without any unnecessary illumination of areas that are spaced apart at a relatively great distance from the place of use.

To provide a light with low power consumption and low heat development, each light may comprise at least one LED as a lamp. It is also possible that such a light comprises two, three or more LEDs.

Furthermore, it is possible that the lights are particularly equally spaced-apart in circumferential direction around the tool element. Each of said lights may comprise one or a corresponding number of LEDs. It is also possible that only one light is provided that, however, comprises a plurality of LEDs and extends e.g. partly or also completely around the tool element on the handle. In this case a circular light would be used.

To prevent a situation where the light gets damaged during the handling of the hand tool, the light may be arranged countersunk in a corresponding surface of the handle. This surface is e.g. the previously mentioned handle end face.

Different light colors are possible for different lamps. When used with the hand tool, it is normally advantageous when the lamp emits substantially white light color. Such a white light color may however show different white shades, such as warm white, daylight white, or neutral white. These corresponding white shades are normally defined by the color temperature.

It is also possible that in response to the place of use and the ambient light the lamp also emits other light colors, such as red color, green color, blue color, or the like. It is also conceivable that in response to the place of use the light color of the light is changed by the light comprising e.g. plural and differently colored LEDs.

For reasons of production and repair it may also be considered to be advantageous when all lights are similarly built up and installed in the hand tool. The manufacturing costs are thereby reduced, and maintenance or replacement of a corresponding light is simplified at the same time.

In this connection it is also possible that the corresponding light is exchangeably installed. This means that in case of damage or failure each light can be replaced by another corresponding light.

Owing to the plurality of the lights and their corresponding arrangement, it is particularly prevented that a shadow occurs in the area of the place of use. The corresponding uniform illumination of the place of use can even possibly be improved when the lights are arranged at the same radial distance from the tool element. This means that the lights can be arranged not only equally spaced-apart in circumferential direction, but also equally spaced apart from the tool element.

Preferably, the hand tool is a particularly electric soldering gun with exchangeable soldering tip as the fastening end section at the end of a tip sleeve or tip holder as the tool element.

In this connection it should also be noted that the tip sleeve or tip holder together with the soldering tip may also be configured on the whole as the exchangeable part. Furthermore, it is conceivable that the light is arranged in a detachable end section of the handle, so that possibly this detachable end section together with tip sleeve/tip holder and soldering tip is an exchangeable part of the hand tool. The corresponding end section of the handle can be used for handling and holding the tip sleeve with soldering tip, whereby a direct contact of the operator with a possibly still hot tip sleeve or hot soldering tip is prevented. It is thus possible by gripping the end section to exchange e.g. the soldering tip together with the tip sleeve/tip holder in an easy way.

Moreover, an exchange of the light or the lights together with the corresponding end section is thereby also carried out.

To be still able to influence the illumination by means of the corresponding light, each light may comprise a cover which particularly determines or influences the radiation angle. This means that the cover may e.g. have an aperture effect which prevents a radiation of light in an undesired direction. Moreover, the cover may have a focusing effect so as e.g. to bundle light emitted by the light source onto a specific area around the place of use or near the place of use.

Advantageous embodiments of the invention shall be explained and described in more detail with reference to the figures enclosed to the drawing.

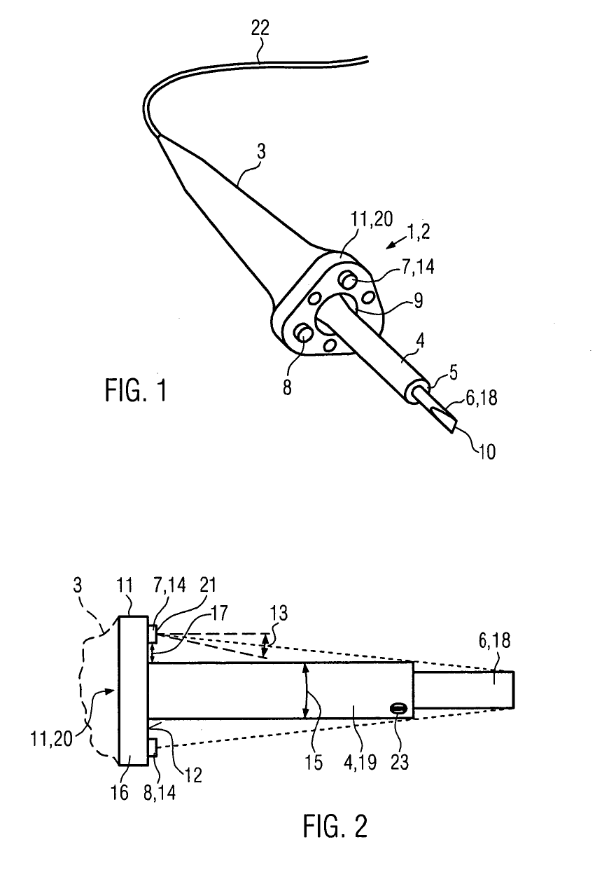

FIG. 1 shows a perspective view on a soldering gun as a hand tool according to the invention, and

FIG. 2 shows a side view on a part of the soldering gun according to FIG. 1.

FIG. 1 shows a perspective view of an embodiment of a tool 1 according to the invention. This tool is configured as an electric soldering gun 2 with handle 3, tip sleeve or tip holder 19 as tool element 4, and soldering tip 18 as actuating end section 6. The handle 3 is configured to be conically tapering in the direction of an electric connection cable 22. At its side facing the tool element 4, the handle 3 comprises a handle end flange 11, see also FIG. 2. The tool element 4 is protruding from the handle 3 and the handle end flange 11, respectively. With the actuating end section 6 arranged on the free end 5 of the tool element 4, the hand tool can be arranged at a corresponding place of use 10 when used by an operator. In the illustrated embodiment the place of use 10 is e.g. a soldering place.

The soldering tip 18 is an exchangeable part; see also FIG. 2, the tip being fixed by means of a screw 23, or the like, in the corresponding position.

For the illumination of the place of use 10 independently of separate lights, or the like, the hand tool 1 comprises three lights 7, 8 and 9. These are equally spaced apart in circumferential direction 15 and are also equally spaced apart in radial direction from the tool element 4, see reference numeral 17 in FIG. 2, in a handle end face 12. This handle end face 12 is the end face of the handle end flange 11 in FIGS. 1 and 2. The corresponding lights 7, 8, 9 are arranged at least partly countersunk in said handle end face. Each of the lights comprises at least one lamp 14 in the form of an LED. The lamps may have the same light color. It is also conceivable that each light uses several lamps optionally also in different light colors.

Each of the lights 7, 8, 9 has a specific radiation angle 13; see FIG. 2. This angle is relatively small to enable a spot-like illumination. As a rule, the radiation angle 13 is between 5° and 30° and preferably between 8° and 20°.

With the corresponding arrangement of the lights 7, 8, 9, a shadow is avoided in the area of the place of use 10. It is also possible that at least one light or also a plurality of said lights 7, 8, 9 are arranged at a different place in a surface 16 of the handle 3 and are there particularly countersunk.

The handle end flange 11 forms an end section 20 of the handle 3 which is adapted to be arranged possibly detachably on the remaining handle 3. The end section 20 may be fastened to the remaining handle, for instance, by way of screws 23, or the like.

Each of the lights 7, 8 and 9 comprises a cover 21 which determines or at least influences the radiation angle of each light. This may be done by way of an aperture effect, a focusing effect, or the like, of the corresponding cover.

For the exchange of the tip sleeve/tip holder 19 with soldering tip 18 and also for the exchange of the lights 7, 8, 9 the whole part of FIG. 2 may be configured as an exchange module. This means that for instance for another soldering case or for the use of another soldering tip the part according to FIG. 2 is removed from the soldering gun 2 and replaced by another corresponding part. The part can be handled by means of the end section 20, so that a contacting of the possibly still hot soldering tip or tip sleeve by an operator is prevented.

However, it may also only be the soldering tip 18 (see the corresponding screw 23 in FIG. 2) that is exchanged.

According to the invention the place of use of the soldering gun 2 is illuminated without detriment to the operator. For instance, according to the invention the operator need not carry along a separate light source. Even if such a light source does not have to be held in the operator's hand, but is fastened to a corresponding place of his/her body, the corresponding light has to be arranged widely spaced-apart from the place of use and the operator must ensure an alignment with the place of use. The arrangement of the lights in the above-described manner provides for an illumination of the place of use that is adequate and accurate at any rate without any additional intervention by the operator.

1-13. (canceled)

14. A hand tool, in particular a soldering gun, having at least one handle and a tool element protruding therefrom with an actuating end section on the free end,
wherein the hand tool has more than one light for illuminating a place of use of the hand tool, and
the lights are arranged on an end flange surrounding the tool element, in a handle end face of the handle extending radially relative to the tool element and oriented substantially in the direction of the place of use, in a triangular arrangement and with an orientation for the shadow-free illumination of the place of use, wherein the handle is configured to be substantially conically tapering in the direction of an electric connection cable.

15. The hand tool according to claim 1, wherein the lights have a radiation angle of 5° to 30° and preferably of 8° to 20°.

16. The hand tool according to claim 1, wherein the lights comprise at least one LED as lamp.

17. The hand tool according to claim 1, wherein the lights are arranged particularly equally spaced-apart in circumferential direction around the tool element.

18. The hand tool according to claim 1, wherein the lights are arranged countersunk in a surface of the handle.

19. The hand tool according to claim 1, wherein the lamp emits a substantially white light color.

20. The hand tool according to claim 1, wherein the lights are similarly built up and installed.

21. The hand tool according to claim 1, wherein the lights are exchangeably installed.

22. The hand tool according to claim 1, wherein the lights are arranged at the same radial distance from the tool element.

23. The hand tool according to claim 1, wherein the hand tool is a particularly electric soldering gun with an exchangeable soldering tip as the actuating end section on the end of a tip sleeve as the tool element.

24. The hand tool according to claim 1, wherein the lights are arranged in a detachable end section of the handle.

25. The hand tool according to claim 1, wherein each light has a cover which particularly determines the radiation angle.

26. The hand tool according to claim 1, wherein the lights emit a shadow-free light in relation to the place of use.
